(19) United States
(12) Patent Application Publication
(10) Pub. No.: US 2002/0006744 A1
(43) Pub. Date: Jan. 17, 2002

(54) Flat cable connector

(76) Inventor: Isao Tashiro, Tokyo (JP)

Correspondence Address: KANESAKA & TAKEUCHI, 1423 Powhatan Street, Alexandria, VA, 22314, US

(21) Appl. No.: 09/881,774

(22) Filed: Jun. 18, 2001

(30) Foreign Application Priority Data
Jul. 11, 2000 (JP) 2000-209495

(51) Int. Cl. H01R 13/62

(52) U.S. Cl. 439/329

(57) ABSTRACT

A flat cable connector consisting of a board connector and a cable connector (21) which comprises a housing (22) having a plugging section (24) pluggable to the board connector and a mounting section (24) having an exposed face (37) on which the connection section (49) of a flat cable (46) is mounted, a terminal (23) having a board section (33) for contact with a terminal of the board connector within the plugging section and a cable section (34) for contact with the conductive pad (50) of the flat cable (46) on the exposed face, and a push plate (40) for pressing down the connection section (49) of the flat cable (46) onto the terminal (23) for keeping electrical conduction between the connection section and the terminal.

### BACKGROUND OF THE INVENTION

1. Field of the Invention

The present invention relates to electrical connectors and, particularly, to a flat cable connector for connecting a flexible flat cable (FFC) and a flexible printed circuit board (FPC).

2. Description of the Related Art

The flat cable connector consists of a board connector mounted on the FPC and a cable connector that is able to plug into the board connector and to which a flat cable is connected by, for example, soldering. The soldering, however, is labor intensive and not environment-friendly.

Japanese patent application Kokai No. 8-264239 discloses a connector that needs no soldering. FIGS. 15 and 16 show the cable connector. The cable connector 1 comprises an insulative housing 3 having a lower opening 2 and a plurality of terminals 4 attached to the housing 3 through the lower opening 2. A board connector (not shown) is plugged through the lower opening 2. A horizontal slot 6 is provided in a side wall 5 of the housing 3 for receiving a flat cable 7 and a flat actuator 8. Each terminal 4 has a pair of leg sections 10 extending downwardly along inner faces of the side wall 5 and the opposed side wall 9 and a linking section 11 for linking upper portions of the leg sections 10. The leg sections 10 should be sufficiently long to establish the effective contact length in terminals between the cable connector 1 and the board connector when they are plugged-in. A cut-out 12 is provided in the linking section 11 to provide a cantilevered flexible arm 13 that extends toward the slot 6.

To connect the cable connector 1 and the flat cable 7, first of all, the flat cable 7 is inserted into the cut-outs 12 through the slot 6 such that the conductors of the flat cable 7 face upwardly and make contact with the flexible arms 13. Then, the flat actuator 8 is inserted under the flat cable 7 while maintaining the contact between the conductors and the flexible arms 13. The flat cable 7 is held under pressure between the flexible arms 13 and the flat actuator 8, thus electrically connecting the terminal 4 and the flat cable 7.

However, the flat cable connector 1 requires much labor to attach the flat cable 7 trough the slot 6 and cut-outs 12 because the flat cable 7 tends to warp and the slot 6 and the cut-outs 12 are very thin. Since the contact between the flat cable 7 and the terminals 4 is held by the resilient power of the flexible arms 13, a pulling force upon the flat cable 7 can cause poor contact or fall of the flat cable 7. There is a section of connection with the flat cable 7 inside the housing 3 so that the cable connector 1 becomes tall by that much. In addition, the actuator 8 cannot be too thin to avoid breaking. As a result, it has been difficult to reduce the height of the cable connector 1. Furthermore, in the above connector that the flat cable 7 is held by the terminals 4, it is impossible to arrange terminals in a zigzag fashion so that the cable connector 1 is not useful for a flat cable having a great number of conductors arranged therein.

### SUMMARY OF THE INVENTION

Accordingly, it is an object of the invention to provide a compact flat cable connector that is easy to attach a flat cable having a great number of conductors arranged therein.

According to one aspect of the invention there is provided a flat cable connector for connecting a flat cable to a printed circuit board, comprising a housing having an exposed face on which a connection section of the flat cable is mounted; at least one terminal provided in the housing and having a board section connectable to a circuit trace of the printed circuit board and a cable section for contact with the connection section of the flat cable; and a push plate for pressing down the connection section of the flat cable onto the terminal on the exposed face for keeping electrical conduction between the connection section and the terminal.

According to another aspect of the invention there is provided a flat cable connector consisting of a board connector to be mounted on a printed circuit board and a cable connector to be connected to a flat cable, the cable connector comprising a housing having a plugging section pluggable to the board connector and a mounting section having an exposed face on which a connection section of the flat cable is mounted; at least one terminal having a board section for contact with a terminal of the board connector within the plugging section and a cable section for contact with a connection section of the flat cable on the exposed face; and a push plate for pressing down the connection section of the flat cable on the terminal for keeping electrical conduction between the connection section and the terminal.

It is preferred that the housing comprises a guide plate to form a space between the guide plate and the mounting section into which the push plate is inserted to press down the connection section of the flat cable onto the terminal for electrical conduction. The exposed face may have at least one projected portion that engages a hole of the flat cable. The projected portion may have a conical form or at least one rib on a side wall thereof. The housing may comprise an abutting wall having at least one key groove therein and the push plate may have at least one key portion that is fitted into the key groove. The push plate may have a resilient retention portion and the housing may have at least one engaging portion for engagement with the retention portion so that when the push plate is inserted to a predetermined position, the retention portion engages the engaging portion. The terminal may have a spring arm extending trough the mounting section so that a front end thereof projects from the exposed face for contact with the connection section of the flat cable. The flat cable connector may further comprises a shield plate for covering at least the plugging section of the housing and having a spring arm projecting from the exposed face for spring contact with the push plate.

By simply pushing the push plate into the housing it is possible to press down the connection section of a flat cable onto the terminal for electrical conduction.

### BRIEF DESCRIPTION OF THE DRAWINGS

FIG. 1 is a plan view of a housing for a flat cable connector according to an embodiment of the invention;

FIG. 2 is a side view of the housing;

FIG. 3 is a sectional view taken along line 3-3 of FIG. 2;

FIG. 4 is a plan view of a push plate for the flat cable connector;

FIG. 5 is a side view of the push plate;

FIG. 6 is a plan view of a flat cable;

FIGS. 7-11 are sectional views of the flat cable connector;

FIG. 12 is a perspective view of part of a flat cable connector according to another embodiment of the invention;

FIG. 13 is a perspective view of a flat cable connector according to still another embodiment of the invention;

FIG. 14 is a perspective view of a projected portion according to yet another embodiment of the invention;

FIG. 15 is a perspective view of a conventional connector; and

FIG. 16 is a sectional view of the conventional connector.

### DESCRIPTION OF THE PREFERRED EMBODIMENT

Embodiments of the invention will now be described with reference to the accompanying drawings.

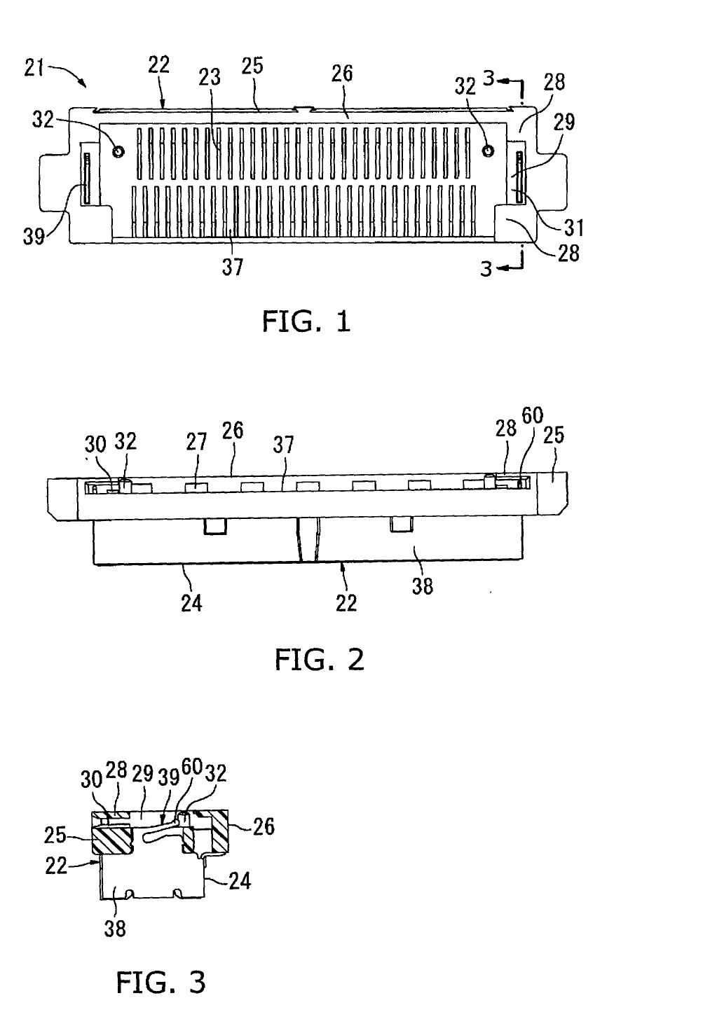

In FIGS. 1-3, the flat cable connector consists of a board connector (not shown) to be mounted on a PCB and a cable connector 21 pluggable to the board connector. The cable connector 21 comprises an insulative housing 22 and a plurality of terminals 23 press fitted into the housing 22 in two rows in a zigzag fashion. The housing 22 has a rectangular plugging section 24 and a flat mounting section 25 provided on the plugging section 24. The mounting section 25 has an exposed face 37 on the top. An abutting wall 26 is provided at the rear edge of the exposed face 37 and a plurality of or seven key grooves 27 are provided inside the abutting wall 26. A pair of front and rear guide plates 28 are provided on opposite sides of the exposed face 37. A cut-out 29 is provided at the central portion of each guide section 28.

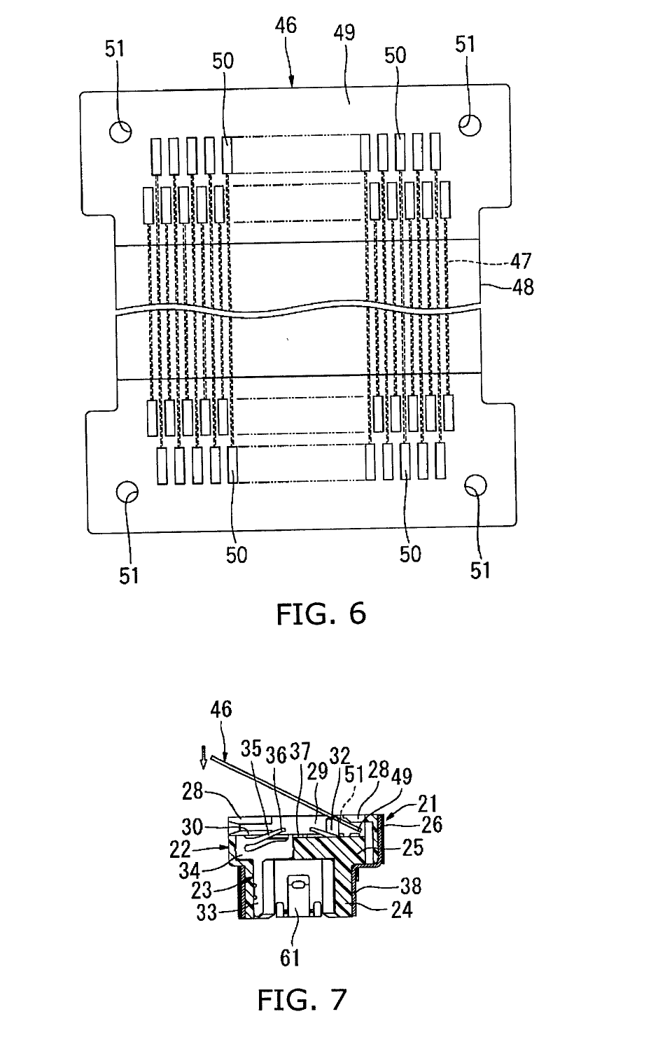

A first raised portion 30 is provided on the exposed face 37 under the guide section 28 and a second raised portion 31 is provided under the cut-out 29. The second raised portion 31 is made lower than the first raised portion 30 by the thickness of the connection section 49 of a flat cable 46 (FIG. 6). A pair of studs 32 are provided on the exposed face 37 and each have a semi-spherical top.

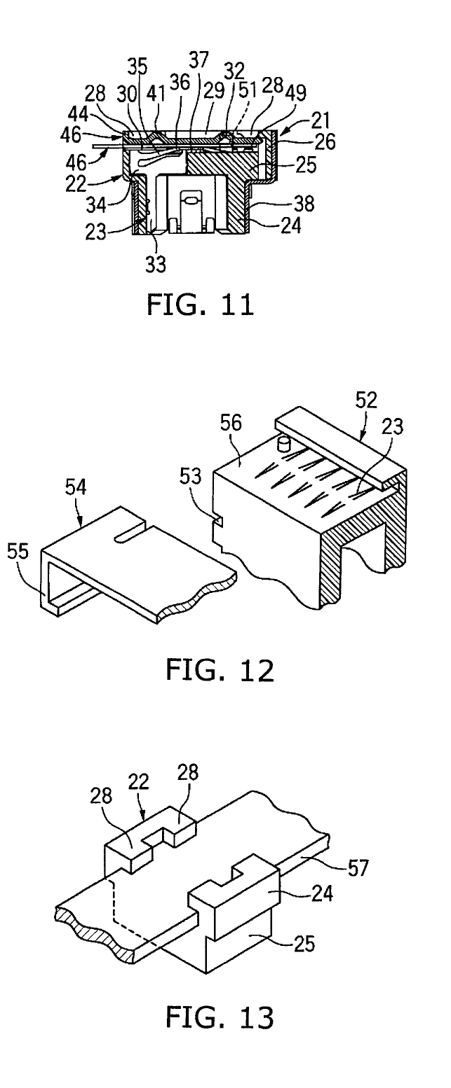

In FIGS. 7-11, each terminal 23 has a base section 33 that is press fitted into the plugging section 24 and a cable section 34 that is press fitted into the mounting section 25. Each base section 33 has an elongated shape and is provided vertically along the inner face of the plugging section 24. A spring arm 35 extends diagonally upwardly from the cable section 34 such that the front end 36 projects from the exposed face 37. Since the spring arm 35 extends upwardly from the lower portion of the cable section 34, not only the height of the mounting section 25 is minimized but also damage to the spring arm 25 is prevented when an excessive force is applied upon the spring arm 25.

A shield plate 38 covers the housing 22 and, as shown in FIG. 3, an upper part of the shield plate 38 extends through the mounting section 25, forming a contact portion 39, which has the same shape as the cable section 34 of the terminal 23; i.e., the front end 60 projects from the exposed face 37 but is slightly higher than the front end 36 of the cable section 34 by the thickness of the connection section 49 of a flat cable 46. As shown in FIG. 7, a lower part 61 of the shield plate 38 is bent into the plugging section 24 so as to contact the shield section of a board connector.

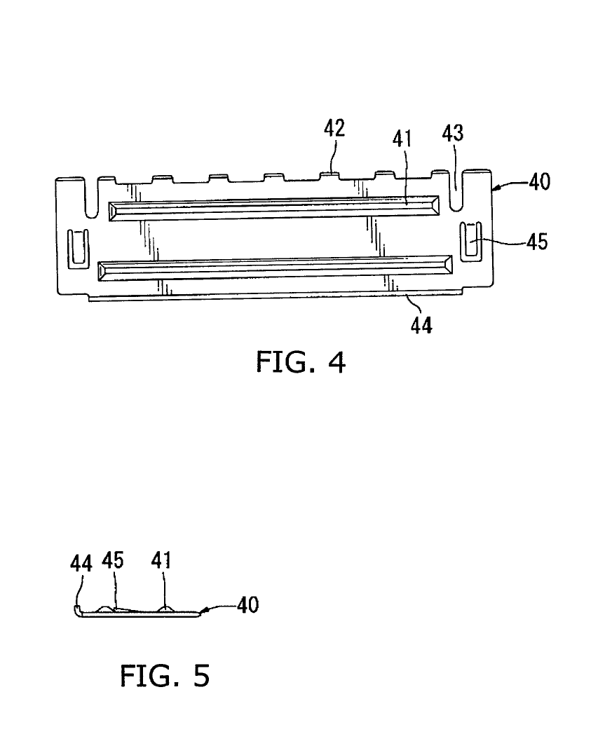

In FIGS. 4 and 5, a push plate 40 is adapted to be mounted on the exposed face 37. It is made of a metal sheet and has a rectangular shape with a pair of parallel ridges 41 extending in the longitudinal direction for reinforcement. The parallel ridges 41 are made shorter than the distance between the guide sections 28. A plurality of or seven key portions 42 are provided on the front edge of the push plate 40 and a pair of cut-outs 43 are provided on opposite sides of the key area. An engaging flange 44 is provided on the rear edge of the push plate 40. A pair of retention tabs 45 are provided on opposite ends of the push plate 40. Each retention tab 45 extends diagonally upwardly and rearwardly in cantilever form.

In FIG. 6, a flat cable 46 is flexible and has a cable body 48 in band form and a pair of widened connection sections 49 on opposite ends. The connection sections 49 are made slightly narrower than the push plate 48. A plurality of signal circuits 47 are provided on a face of the cable body 48 and a ground plane is provided on the other face of the cable body 48. A plurality of conductive pads 50 are provided on the connection section 49 in zigzag fashion in two rows. A pair of holes 51 are provided in the connection section 49 at the outer corners for engagement with the projected portions 32.

How to connect the flat cable 46 to the cable connector 21 will be described with respect to FIGS. 7-11.

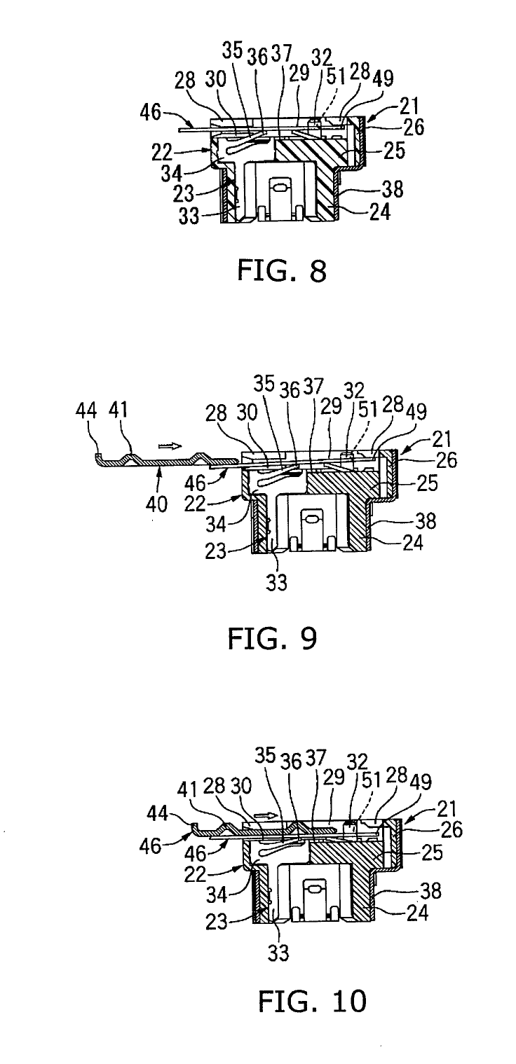

As shown in FIG. 7, the connection section 49 of the flat cable 46 is inserted into a space under the guide section 28 of the connector 21, with the ground face faced upwardly. Then, as shown in FIG. 8, the flat cable 46 is brought to a flat position such that the projected portions 32 engage the holes 51 for temporally holding. The connection section 49 is shorter than the distance between the abutment wall 26 and the front-side guide plate 28 and narrower than the push plate 40 so that it is mounted on the second raised portion 31 without difficulty but makes no contact with the contact section 39 of the shield plate 38.

Then, in FIGS. 9-11, the push plate 40 is inserted between the guide plates 28 and the first raised portions 30. Since the first raised portions 30 are higher than the second raised portions 31 by the thickness of the flat cable 46, the connection section 49 does not interfere with the front portion of the push plate 40 so that the push plate 40 is inserted without difficulty. The flat cable 46, which is fixed temporally, does not move during the insertion of the push plate 40. When the push plate 40 is inserted into a predetermined position, with the spring arms 35 are flexed downwardly, the front ends 36 of the spring arms 35 are brought into contact with the respective conductive pads 50 under a predetermined pressure, thus electrically connecting the terminals 23 and the flat cable 46.

The projected portions 32 engage the holes 51, positioning accurately the conductive pads 50 with respect to the cable sections 34 of the terminals 23 so that the conductive pads 50 are brought into contact with the front ends 36 of the board sections 33 without failure. The contact section 39 is flexed downwardly to make contact with the opposite ends of the push plate 40 under a predetermined pressure and the ground face of the flat cable 46 makes contact with the push plate 40 so that cable connector 21 is shielded entirely. At this point, the key portions 42 are fitted in the key grooves 27 and the projected portions 32 engage the holes 51 as well as the retention portions or tabs 45 engage the rear side guide plate 28 and the engaging flange 44 abuts on the front-side guide plates 28 so that the horizontal movement of the push plate 40 is prevented. Also, the upward movement of the push plate 40 is prevented by the guide plates 28 and the key grooves 27. Consequently, the push plate 40 neither moves out of place nor falls from the housing 22, thus keeping the conduction between the flat cable 46 and the terminals 23. Since the contact section 39 is protruded from the front ends 36 by the thickness of the connection section 49 of flat cable 46, the contact pressure between the push plate 40 and the contact section 39 is kept at an appropriate level and the shield condition of the cable connector 21 is maintained without failure.

In addition, during the insertion of the push plate 40, the parallel ridges 41 do not interfere with the guide plates 28 or the other component of the mounting section 25 so that it is not necessary to increase the height of the mounting section 25 by the thickness of the ridges 41. As a result, by providing the ridges 41 it is possible to reduce the height of the mounting section 25 by the reduction in the thickness of the push plate 40.

In FIG. 12, according to another embodiment of the invention, a guide groove 53 is provided in each side wall of the housing 52 to receive an engaging flange 55 of a push plate 54 so that the push plate 54 pushes the connection section 49 of a flat cable 46 on the terminals 23. The push plate 40 or 54 may take other forms as long as it can press the connection section 49 onto the terminals 23.

In FIG. 13, the conductive pads 50 in the above embodiments are replaced by conductive pads (not shown) that are provided on the intermediate portion of a flat cable 57 and the abutment wall 26 is eliminated from the housing 22 such that the conductive pads are connected to the cable connector.

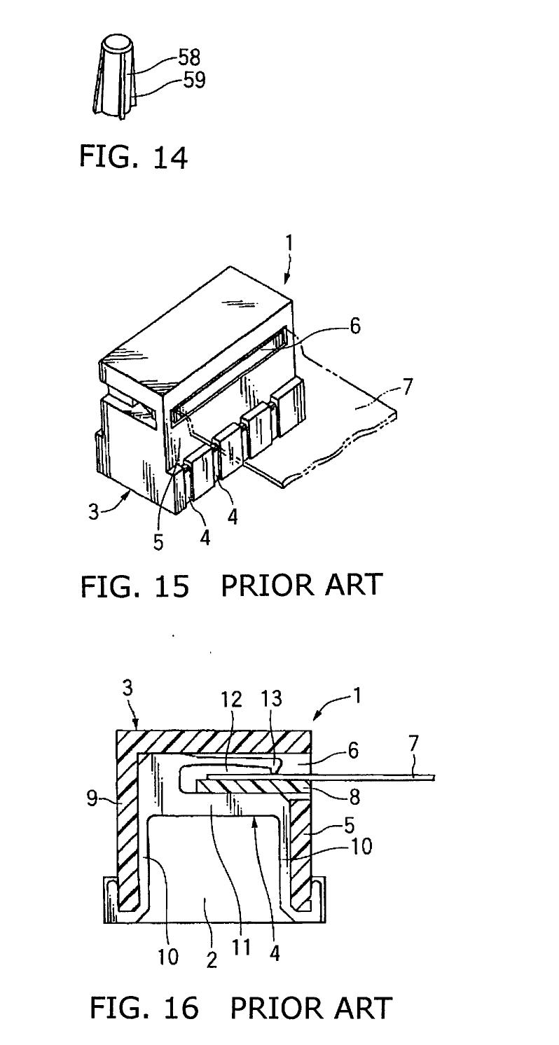

In FIG. 14, in this embodiment, the projected portion 32 is replaced by a cylindrical column 58 with ribs 59 provided on the side wall to not only absorb an error in engagement with the hole 51 but also prevent play of the flat cable 57 when the flat cable 57 is moved toward the exposed face 37 by the push plate 40 to eliminate the gap between the cylindrical column 58 and the hole 51.

The retention portions 45 may take other forms provided on either upper, lower, or side face as far as they can engage the engaging portions that are provided on the mounting section 24 or 56. The base portion of the engaging flange 44 may be folded back 180 degrees for reinforcement. The plugging structure between the board connector and the cable connector may be modified. Also, the invention may be used for connectors that are attached directly to a board without the use of the board connector.

As has been described above, according to the invention, a flat cable is attached to the cable connector simply by pushing the connection section of the flat cable with the push plate onto the exposed face of a housing so that the attachment of the flat cable is simplified. In addition, the holes of a flat cable engage the raised portions to temporally fix the flat cable, making the attachment operation easy. The flat cable is held securely at a predetermined position after the push plate is attached so that it neither makes poor contact with the terminals nor falls from the connector.

The key portions at the front edge of the push plate engage the key grooves of the abutting wall and the retention tabs of the push plate engage the engaging portions of the guide plates so that falling of the push plate is prevented. The spring arms of terminals make it possible to reduce the height of the housing and miniaturize the connector. The plugging section of the housing is covered by the shield plate and the exposed face of the housing is covered by the push plate, and the shield plate and the push plate are brought into contact with each other, the cable connector is shielded simply and surely. The flat cable is placed on the terminals so that there are many design choices including a plurality of rows of terminals arranged.

1. A flat cable connector for connecting a flat cable to a printed circuit board, comprising:
a housing having an exposed face on which a connection section of said flat cable is mounted;
at least one terminal provided in said housing and having a board section connectable to a circuit trace of said printed circuit board and a cable section for contact with said connection section of said flat cable; and
a push plate for pressing down said connection section of the said flat cable onto said terminal on said exposed face for keeping electrical conduction between said connection section and said terminal.

2. A flat cable connector consisting of a board connector to be mounted on a printed circuit board and a cable connector to be connected to a flat cable,
said cable connector comprising:
a housing having a plugging section pluggable to said board connector and a mounting section having an exposed face on which a connection section of said flat cable is mounted;
at least one terminal having a board section for contact with a terminal of said board connector within said plugging section and a cable section for contact with a connection section of said flat cable on said exposed face; and
a push plate for pressing down said connection section of said flat cable on said terminal for keeping electrical conduction between said connection section and said terminal.

3. The flat cable connector according to claim 2, wherein said housing comprises a guide plate to form a space between said guide plate and said mounting section into which said push plate is inserted to press down said connection section of said flat cable onto said terminal for electrical conduction.

4. The flat cable connector according to claim 2, wherein said exposed face has at least one projected portion that engages a hole of said flat cable.

5. The flat cable connector according to claim 4, wherein said projected portion has a conical form.

6. The flat cable connector according to claim 4, wherein said projected portion has at least one rib on a side wall thereof.

7. The flat cable connector according to claim 3, wherein said housing comprises an abutting wall having at least one key groove therein and said push plate has at least one key portion that is fitted into said key groove.

8. The flat cable connector according to claim 3, wherein said push plate has a resilient retention portion and said housing has at least one engaging portion for engagement with said retention portion so that when said push plate is inserted to a predetermined position, said retention portion engages said engaging portion.

9. The flat cable connector according to claim 2, wherein said terminal has a spring arm extending trough said mounting section so that a front end thereof projects from said exposed face for contact with said connection section of said flat cable.

10. The flat cable connector according claim 2, which further comprises a shield plate for covering at least said plugging section of said housing and having a spring arm projecting from said exposed face for spring contact with said push plate.
